(19) United States
(12) Patent Application Publication
(10) Pub. No.: US 2023/0273508 A1
(43) Pub. Date: Aug. 31, 2023

(54) OMNIDIRECTIONAL CAMERA MODULE COMPRISING DOME-SHAPED COVER UNIT

(71) Applicant: EPICOPTIX, Seongnam-si, Gyeonggi-do (KR)

(72) Inventors: Dong Ha KIM, Gangneung si, Gangwon-do (KR); Young Il KIM, Seongnam-si, Gyeonggi-do (KR); Byeong Soo SON, Yongin-si, Gyeonggi-do (KR); Gye Won SEO, Gwangju-si, Gyeonggi-do (KR); Sang Jun LEE, Suwon-si, Gyeonggi-do (KR)

(73) Assignee: EPICOPTIX, Seongnam-si, Gyeonggi-do (KR)

(21) Appl. No.: 18/014,731

(22) PCT Filed: Jul. 29, 2021
(86) PCT No.: PCT/KR2021/009874

§ 371 Date: Jan. 5, 2023

(30) Foreign Application Priority Data
Sep. 23, 2020 (KR) 10-2020-0123045

(51) Int. Cl. G03B 17/17; G03B 17/12; G02B 7/02; G03B 37/00

(52) U.S. Cl. CPC G03B 17/17; G03B 17/12; G02B 7/021; G03B 37/00

(57) ABSTRACT

Disclosed is an omnidirectional camera module comprising a dome-shaped cover unit, including: a body including a barrel portion in which a plurality of lenses are disposed in series and through which light introduced from one side travels and an extended portion formed to have a relatively large area on one side of the barrel portion and to communicate with the barrel portion at a central portion; a cover unit having a shape convex to the front, having at least a portion made of a light transmitting material, surrounding the extended portion at the front, and forming a reflection space therein; and a reflection unit including a first reflective portion formed on a front surface of the extended portion inside the reflection space, and a second reflective portion disposed to face the first reflective portion inside the cover unit to reflect the light reflected by the first reflective portion again.

### TECHNICAL FIELD

The present disclosure relates to an omnidirectional camera module including a dome-shaped cover unit. More specifically, the present disclosure relates to an omnidirectional camera module including a dome-shaped cover unit capable of serving as a lens for an omnidirectional camera by separately including a cover unit responsible for a refraction surface and a reflection unit responsible for a reflective surface and coupling with each other, without processing a separate lens.

### BACKGROUND ART

Most of the recent mobile communication terminals are provided with a camera, and most of these cameras use a compact camera to which a CMOS or a CCD image sensor is applied.

In general, the compact camera is assembled with a lens and a housing after the CMOS or the CCD image sensor is mounted on a printed circuit board, and then, is electrically connected to a flexible printed circuit board that electrically communicates with the outside to operate a camera module.

However, this camera module is used in various ways, and is miniaturized in size depending on the purpose, and correspondingly, an area that can be photographed itself is also reduced according to the miniaturization.

In order to solve the above problem, a camera module with a wide field of view has been developed through a fisheye lens or a special lens, and as this special lens is applied to an omnidirectional camera, it is possible to have a wide angle of field and photograph an image with a miniaturized camera.

A fisheye lens is mainly used as a lens used in the omnidirectional camera module. However, in the case of the fisheye lens, a large angle of view can be secured, but image distortion occurs. Therefore, in recent years, a special lens is manufactured and used instead of the fisheye lens.

However, in the case of the special lens used in the omnidirectional camera, a lens formed to have a certain curvature includes a refraction surface and a reflective lens in a complex manner, and this lens is difficult to manufacture, which increases a manufacturing cost. Further, in the case of such lens, a method in which a plurality of parts are manufactured and then bonded is used, which substantially increase the number of the manufacturing processes and causes the cost increase.

### DISCLOSURE

### Technical Problem

The present disclosure is devised to solve the above problems in the related art, and is to provide an omnidirectional camera module including a dome-shaped cover unit capable of reducing the manufacturing cost of the omnidirectional camera module and improving processability by being provided with a dome-shape cover unit made of a light transmitting material and a separate reflection unit therein without separately processing a lens.

The object of the present disclosure is not limited to the object mentioned above, and other objects that are not mentioned will be clearly understood by those skilled in the art from the following description.

### Technical Solution

An omnidirectional camera module including a dome-shaped cover unit of the present disclosure for achieving the above object includes: a body including a barrel portion in which a plurality of lenses is disposed in series and through which light introduced from one side travels and an extended portion formed to have a relatively large area on one side of the barrel portion and to communicate with the barrel portion at a central portion; a cover unit having a shape convex to the front, having at least a portion made of a light transmitting material, surrounding the extended portion at the front, and forming a reflection space therein; and a reflection unit including a first reflective portion formed on a front surface of the extended portion inside the reflection space to reflect light transmitted through the cover unit to the front, and a second reflective portion disposed to face the first reflective portion inside the cover unit to reflect the light reflected by the first reflective portion again so as to transmit the light to the barrel portion.

Further, the extended portion may be formed to be curved in a shape convex at a central portion of a front surface, and may be formed to communicate with an inside of the barrel portion, and the first reflective portion may be formed to be convex corresponding to a shape of the front surface of the extended portion and is disposed toward the front inside the reflection space.

Further, the first reflective portion may include a first transmitting hole communicating with the barrel portion at a central portion so that light reflected by the second reflective portion may be traveled to the inside of the barrel portion.

Further, the second reflective portion may be disposed to face the first reflective portion and may be disposed at the front of the barrel portion inside the cover unit.

Further, the first reflective portion may be configured as a separate member and may be disposed on the front surface of the extended portion in a state of being coupled to the cover unit.

Further, the second reflective portion may include a second transmitting hole at the central portion facing to the barrel portion so as to transmit light introduced through the front of the cover unit and to make the light to be traveled to the barrel portion directly.

Further, the cover unit may further include an auxiliary lens formed in at least a part of the front of the second reflective portion and inducing the transmitted light to be transmitted to the second transmitting hole.

Further, the first reflective portion may be formed as a separate coating form on the front surface of the extended portion.

Further, the cover unit may include a first coupling portion formed to surround at least a part along a periphery of the extended portion, and formed on an edge along the periphery as a protrusion or a groove, and the extended portion may include a second coupling portion that is selectively coupled corresponding to the first coupling portion formed in the cover unit so as to be selectively coupled with each other.

### Advantageous Effects

The omnidirectional camera module including the dome-shaped cover unit of the present disclosure for achieving the above object has the following effects.

According to the omnidirectional camera module including the camera dome-shaped cover unit of the present disclosure, the dome-shaped cover unit serving as a refraction surface and the reflection unit serving as a reflective surface are separately configured and fastened at the front of the barrel portion in an extended form, thereby realizing the same effect as a wide-angle lens without a separate wide-angle lens.

The effect of the present disclosure is not limited to the effect mentioned above, and other effects that are not mentioned will be clearly understood by those skilled in the art from the claims.

### DESCRIPTION OF DRAWINGS

FIG. 1 is a schematic view illustrating a configuration of a camera module according to an embodiment of the present disclosure;

FIG. 2 is an exploded perspective view illustrating a specific internal configuration of the camera module in FIG. 1;

FIG. 3 is a cross-sectional view illustrating an inside of the camera module in FIG. 1;

FIG. 4 is a view illustrating a state in which light is transmitted to a barrel portion in the camera module in FIG. 3;

FIG. 5 is a view illustrating a modification of a cover unit of the camera module in FIG. 1; and

FIG. 6 is a view illustrating a form in which light is incident on the front of the cover unit in the camera module in FIG. 5.

### BEST MODE

Hereinafter, embodiments of the present disclosure capable of specifically realizing the object of the present disclosure will be described with reference to the accompanying drawings. In describing the present embodiments, the same names and the same reference numerals are used for the same components, and an additional description thereof will be omitted.

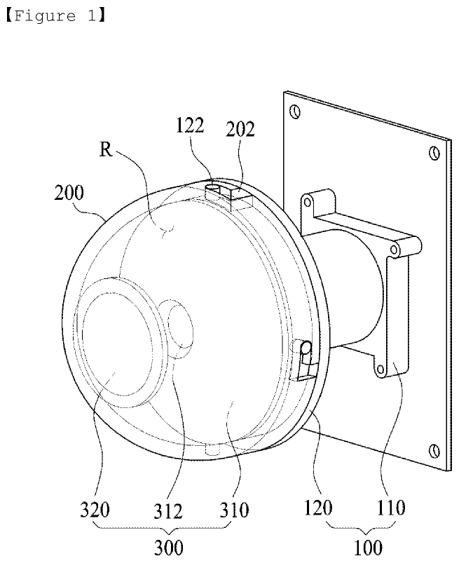

First, with reference to FIGS. 1 to 4, a configuration of an omnidirectional camera module including a dome-shaped cover unit according to the present disclosure will be schematically described as follows.

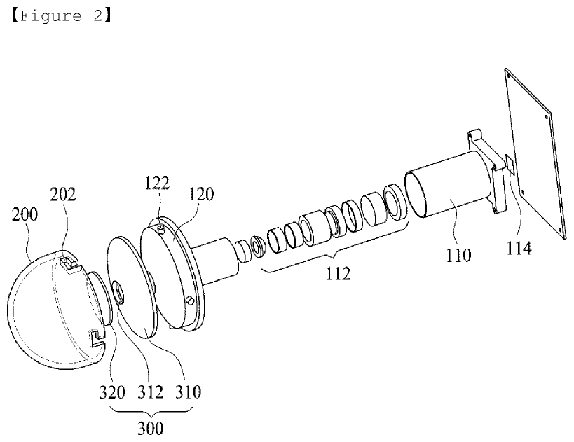

FIG. 1 is a schematic view illustrating a configuration of a camera module according an embodiment of the present disclosure, and FIG. 2 is an exploded perspective view illustrating a specific internal configuration of the camera module in FIG. 1.

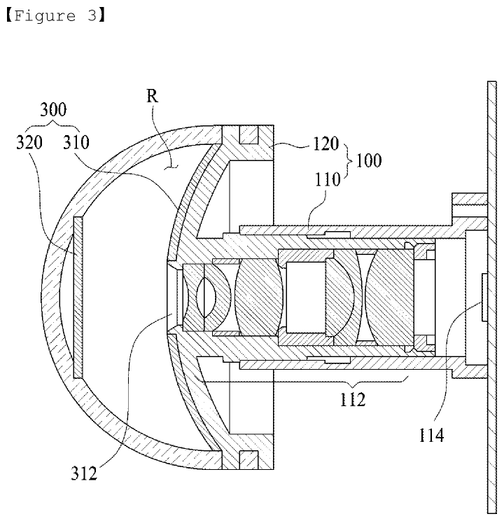

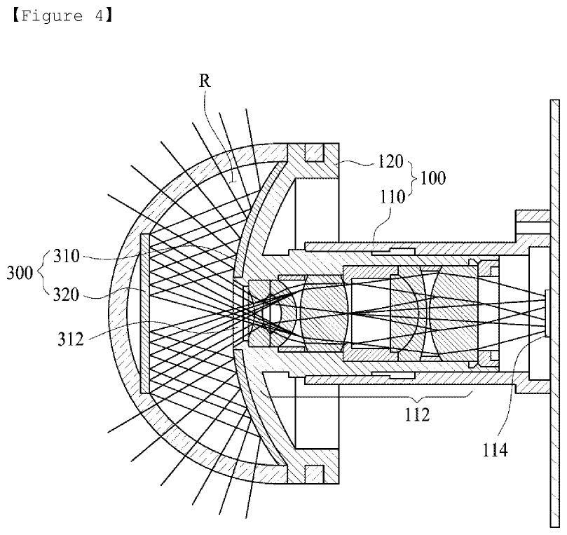

FIG. 3 is a cross-sectional view illustrating an inside of the camera module in FIG. 1, and FIG. 4 is a view illustrating a state in which light is transmitted to a barrel portion in the camera module in FIG. 3.

The present disclosure relates a camera module that can photograph an image by collecting light transmitted from the front through a cover unit 200 having a convex shape at a wide angle, and mainly includes a body 100, the cover unit 200, and a reflection unit 300.

The body 100 forms an overall shape, and is configured to have a traveling path through which light is transmitted therein so that an image is photographed through a separate image sensor 114. At this time, the body 100 includes the cover unit 200 (to be described later) at one side and is fixed to a separate installation surface at the other side so that an image may be collected from the front in a wide angle.

In the present disclosure, as illustrated, the body 100 mainly includes a barrel portion 110 through which light passing through the cover unit 200 travels and an extended portion 120 formed to have a relatively large area at the front of the barrel portion 110 and including a hole communicating with the barrel portion 110 at a central portion.

The barrel portion 110 has a cylindrical shape and a traveling path of light is formed therein such that the light passes through an inner communicating hole through the hole opened on one side, and a plurality of lenses is disposed in series in the communicating hole to make the light to be traveled. Here, the extended portion 120 (to be described later) is disposed on one side of the barrel portion 110, and the image sensor 114 that measures the image of the light transmitted through the barrel portion 110 is provided on the other side.

In this manner, the barrel portion 110 has the travelling path of the light therein and light introduced from one side is transmitted to the image sensor 114 provided on the other side via the plurality of lens array 112.

Meanwhile, the extended portion 120 is provided at one side of the barrel portion 110 to be coupled with the reflection unit 300 and the cover unit 200 (to be described later), and is formed so as to induce the reflection of the light introduced from the front.

Specifically, the extended portion 120 is relatively largely formed along the periphery at the front end portion of the barrel portion 110, and a hole of the barrel portion 110 is formed at the central portion. Here, the extended portion 120 is provided with a part of the reflection unit 300 (to be described later) on the front surface, and is configured such that the reflection unit 300 can be disposed in a shape convex to the front.

In the embodiment, the extended portion 120 is formed such that the central portion of the front surface is formed to be curved in a convex shape so as to be communicated with the inside of the barrel portion 110. However, in contrast, the front surface of the extended portion 120 may extend simply the periphery thereof in a plane shape so as to have a relatively large area.

In this manner, the body 100 according to the present disclosure forms a basic shape, and is configured to include the cover unit 200 and the reflection unit 300 (to be described later) at the extended portion 120 formed at the front so as to collect light in a wide angle and transmit the light to the inside of the barrel portion 110.

Meanwhile, the cover unit 200 has a shape convex to the front, at least a part thereof is made of a light transmitting material. The cover unit 200 surrounds the extended portion 120 at the front and forms a reflection space R therein.

Specifically, the cover unit 200 is disposed in a convex shape at the front of the extended portion 120, and is formed in a shape surrounding along the periphery of the extended portion 120. At this time, the cover unit 200 is formed in a shape convex to the front of the extended portion 120, and the separate reflection space R is formed between the front surface of the extended portion 120 and the inner surface of the cover unit 200 to be able to make light to be traveled and to be reflected.

In the present disclosure, the cover unit 200 is made of a light transmitting material, is coupled in a shape surrounding a part of the side surface along the periphery of the extended portion 120, and protrudes in a convex shape at the front surface of the extended portion 120 to form the reflection space R therein.

At this time, the cover unit 200 is formed in a general dome shape made of glass or synthetic resin material to form the reflection space R therein, and is formed to be selectively coupled to or separated from the extended portion 120.

Specifically, the cover unit 200 includes a first coupling portion 202 formed to surround at least a part along the periphery of the extended portion 120, and formed on an edge along the periphery as a protrusion or a groove. Then, the extended portion 120 further includes a second coupling portion 122 that is selectively coupled corresponding to the first coupling portion 202 formed in the cover unit 200.

Here, the first coupling portion 202 and the second coupling portion 122 are engaged with each other, as a result, the cover unit 200 may maintain a state of being coupled to the extended portion 120 and the cover unit 200 may be separated by an operation by a user. In the embodiment, the first coupling portion 202 is formed as a groove form, and the second coupling portion 122 is formed as a protrusion. The first coupling portion 202 is not a simple groove but a bent-shaped groove, and as illustrated, the second coupling portion 122 moves along the shape of the first coupling portion 202 to maintain the coupled state.

In this manner, the cover unit 200 is fixedly coupled to the extended portion 120 by the first coupling portion 202 and the second coupling portion 122, and the first coupling portion 202 and the second coupling portion 122 may be formed in various forms.

Meanwhile, the reflection unit 300 is constituted by a plurality of parts and is configured to reflect light introduced to the inside of the cover unit 200 in the reflection space R to transmit the light to the inside of the barrel portion 110, and mainly includes a first reflective portion 310 and a second reflective portion 320.

Specifically, the reflection unit 300 includes the first reflective portion 310 disposed on the front surface of the extended portion 120 in the reflection space R and the second reflective portion 320 that reflects the reflected light again at a position facing to the first reflective portion 310 to transmit the light to the barrel portion 110.

The first reflective portion 310 is formed on the first surface of the extended portion 120 so as to primarily reflect light transmitted through the cover unit 200. At this time, the first reflective portion 310 is formed on the front surface of the extended portion 120 and reflects the light, and is formed in a shape convex at the central portion with a predetermined curvature.

Here, the first reflective portion 310 has a curvature different from the curvature of the cover unit 200, and reflects each light having various incident angles transmitted through the cover unit 200 and transmits the light toward the second reflective portion 320 (to be described later).

In the present disclosure, the first reflective portion 310 is formed in a general reflective mirror shape and is formed in a shape convex on the front surface of the extended portion 120. Then, a first transmitting hole 312 communicating with the barrel portion 110 is formed at the central portion so that the light reflected again by the second reflective portion 320 (to be described later) may be traveled to the inside of the barrel portion 110.

In the embodiment, the first reflective portion 310 is configured as a member separated from the extended portion 120 and is coupled to the front surface. The extended portion 120 is formed to protrude in a convex shape, and correspondingly, the first reflective portion 310 is formed in a convex shape.

Of course, in contrast, although the front surface of the barrel portion 110 is formed in a flat-plate shape instead of the convex shape, the first reflective portion 310 is necessary to be formed to protrude so that the central portion of the front surface is convex to have a predetermined curvature, and the first transmitting hole 312 is formed at the central portion.

As illustrated, the first reflective portion 310 is formed as a member separated from the extended portion 120 and is configured to be disposed on the front surface of the extended portion 120 at the time of the coupling with the cover unit 200. However, in contrast, the first reflective portion 310 may be applied in a coating form to the front surface of the extended portion 120.

In a case where the first reflective portion 310 is formed in a coating form, it is required that the front surface of the extended portion 120 is formed in a convex shape in order for the first reflective portion 310 to be formed in a convex shape.

In this manner, the first reflective portion 310 according to the present disclosure is disposed on the front surface of the extended portion 120 in the reflection space R, and reflects light transmitted through the cover unit 200 from the outside at a constant angle to transmit to the front.

Meanwhile, the second reflective portion 320 is provided inside the cover unit 200 and is disposed to be apart from the front of the extended portion 120, and reflects the light transmitted from the first reflective portion 310 again to transmit to the inside of the barrel portion 110.

Specifically, the second reflective portion 320 is disposed to face the first reflective portion 310 and is configured to reflect the light reflected by the first reflective portion 310 again, and is positioned at the convex central portion of the cover unit 200. Here, the second reflective portion 320 has a certain level of area so that the light transmitted through the first reflective portion 310 may be transmitted to the inside of the barrel portion 110, and may be configured in a flat-plate shape or a shape having a certain curvature.

In the embodiment, as illustrated, the second reflective portion 320 is configured as a separate member and is coupled at the inner central of the cover unit 200. However, in contrast, the second reflective portion 320 may be directly formed in a reflective coating form on the inner surface of the cover unit 200. In a case where the second reflective portion 320 is formed in the reflective coating form, the second reflective portion 320 may be formed in a flat-plate shape or a shape having a certain curvature at the position corresponding to the inner surface of the cover unit 200 so as to form the shape of the second reflective portion 320.

In this manner, the second reflective portion 320 is disposed in a form facing the front of the first reflective portion 310, and reflects the light transmitted from the first reflective portion 310 again to transmit to the inside of the barrel portion 110 through the hole formed at the central portion of the first reflective portion 310.

That is, the light transmitted through the cover unit 200 is reflected by the first reflective portion 310 and transmitted to the second reflective portion 320, and the second reflective portion 320 reflects the light again to transmit to the barrel portion 110 so that the light incident through the cover unit 200 is transmitted to the inside of the barrel portion 110 to be able to secure an image of a wide field of view.

In this manner, the reflection unit 300 according to the present disclosure reflects light through the first reflective portion 310 and the second reflective portion 320, respectively, so as to reflect and transmit the light transmitted from the cover unit 200 at a wide angle to the inside of the barrel portion 110.

Therefore, without additional deformation or modification on the barrel portion 110, it is possible to collect an image that secures a wide angle of field by being provided with the dome-shaped cover unit 200 and the reflection unit 300 at the front of the barrel portion 110, respectively.

As described above, the camera module according to the present disclosure includes the body 100, the cover unit 200, and the reflection unit 300, the cover unit 200 is coupled to the extended portion 120 formed at the front of the body 100, and the reflection unit 300 is seated inside the cover unit 200.

At this time, the first reflective portion 310 may be configured as a separate member and disposed on the front surface of the extended portion 120 in a state of being coupled with the cover unit 200. Otherwise, the cover unit 200 may be coupled with the extended portion 120 in a state where the first reflective portion 310 is coupled with the extended portion 120.

That is, in the case where the first reflective portion 310 is configured as a separate member, the cover unit 200 and the extended portion 120 are fastened to each other while the first reflective portion 310 is coupled to at least one of the extended portion 120 or the cover unit 200, and thus, the first reflective portion 310 may be disposed on the front surface of the extended portion 120.

Meanwhile, when looking at the image of the light transmitted through the cover unit 200 in more detail, as illustrated in FIG. 4, first, external light is transmitted through the cover unit 200 and is transmitted to the inside of the reflection space R. At this time, when transmitting through the cover unit 200, a part of light may be refracted due to the difference in refractive rate, and most of the refracted light is transmitted to the first reflective portion 310 and is reflected.

At this time, the inside of the cover unit 200 is an empty space filled with air, the first reflective portion 310 and the second reflective portion 320 are disposed therein, and it is desirable to be sealed so as not to be introduced foreign matters from the outside. Here, in order to adjust the degree of the refraction of light incident into the reflection space R, the material of the cover unit 200 may be changed, or a light transmitting material may be filled with the inside of the reflection space R.

In this manner, the light transmitted through the cover unit 200 is reflected to the front by the first reflective portion 310. At this time, the first reflective portion 310 is formed in a shape convex at the central portion to have a predetermined curvature, and thus, although the incident angles of the light transmitted through the dome-shaped cover unit 200 are different from each other, the light is reflected toward the second reflective portion 320 positioned at the front.

Then, the light reflected by the first reflective portion 310 is reflected again by the second reflective portion 320 and is transmitted to the inside of the barrel portion 110, and thus, the image sensor 114 may collect an image at a wide angle through the transmitted light.

In this manner, the camera module according to the present disclosure may collect and photograph a wide angle image through the image sensor 114 by reflecting light incident through the cover unit 200 formed in a dome shape toward the front a plurality of times and transmitting the light to the inside of the barrel portion 110.

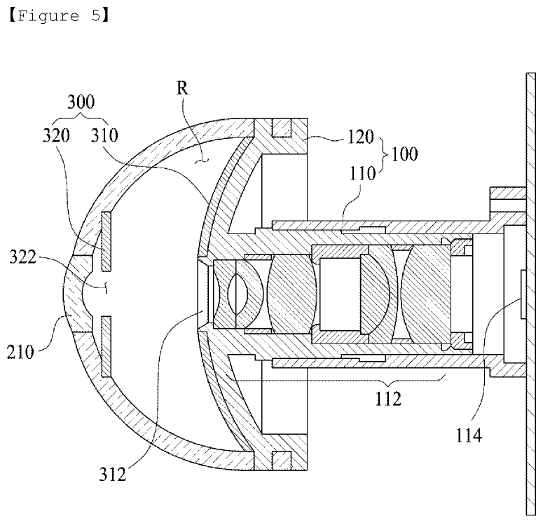

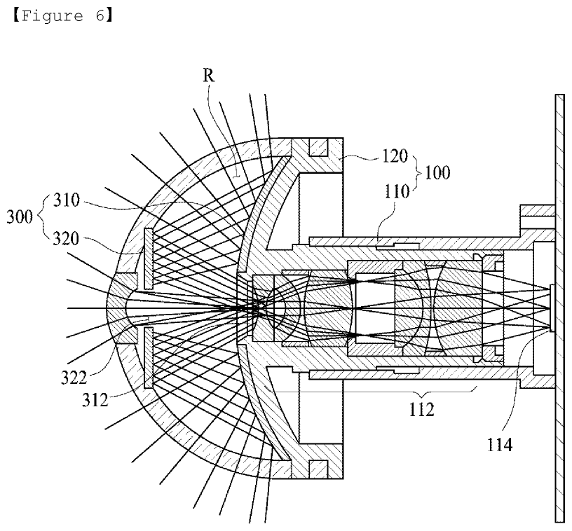

Subsequently, with reference to FIGS. 5 and 6, a modification of the omnidirectional camera module according to the present disclosure will be described as follows.

FIG. 5 is a view illustrating a modification of a cover unit 200 of the camera module in FIG. 1; and FIG. 6 is a view illustrating a form in which light is incident on the front of the cover unit 200 in the camera module in FIG. 5.

First, when looking at the camera module of the modification, the basic configuration is similar to that of the embodiment, but the configuration of the second reflective portion 320 is different, and additionally, a separate auxiliary lens 210 is further provided.

Specifically, the second reflective portion 320 includes a separate second transmitting hole 322 that transmits light introduced through the central portion of the cover unit 200, and the light introduced by passing through the second transmitting hole 322 is directly transmitted to the barrel portion 110 without passing through the reflection unit 300.

At this time, the second transmitting hole 322 is formed at a position facing the front of the hole formed in the barrel portion 110, and transmits a part of light that is not transmitted at the central portion as the second reflective portion 320 is disposed in the cover unit 200, and thus, it is possible to additionally collect the image of the central portion of the area corresponding to the shape of the cover unit 200.

Meanwhile, in the modification, the cover unit 200 further includes the auxiliary lens 210 formed in at least a part of the front of the second reflection unit 300 and transmitting the transmitted light to the second transmitting hole 322.

As illustrated, the auxiliary lens 210 is disposed at the front of the second transmitting hole 322 at the protruding central portion of the cover unit 200, collects the light that is not transmitted to the inside of the reflection space R and blocked by the second reflective portion 320, and transmits the light to the second transmitting hole 322.

At this time, the auxiliary lens 210 is formed in a convex shape protruding to the front, and refracts light introduced from a certain area to transmit to the second transmitting hole 322.

Therefore, the blockage of the light transmitted from the central portion as the second reflective portion 320 is disposed in the cover unit 200 is minimized, and some of the light is directly transmitted to the barrel portion 110 through the second transmitting hole 322, and thus, the omission of the image can be minimized.

Here, one surface of the auxiliary lens 210 is made of a light transmitting material having a convex shape, and is disposed at the front of the second reflection unit 300 at the protruding central portion of the cover unit 200, and thus, light from a relatively wide area may be refracted and transmitted to the second transmitting hole 322.

In this manner, the camera module according to the present disclosure may configure a camera module capable of securing a wide angle image with the cover unit 200 serving as a refraction surface and a lens itself and the reflection unit 300 serving as a reflective surface, without separately manufacturing and bonding a plurality of lenses, or separately processing a refraction surface and a reflective surface when processing the lens.

[symbol]

As described above, preferred embodiments according to the present disclosure have been described, and it should be appreciated by those skilled in the art that the present disclosure may be embodied in other specific forms in addition to the embodiments described above without departing from the spirit or scope of the present disclosure. Accordingly, the above-described embodiments are to be considered illustrative rather than restrictive, and thus, the present disclosure is not limited to the above description, but may be modified within the scope of the appended claims and their equivalents.

[symbol]

### DESCRIPTION OF SYMBOL

100: body
110: barrel portion
120: extended portion
200: cover unit
210: auxiliary lens
300: reflection unit
310: first reflective portion
320: second reflective portion
R: reflection space

1. An omnidirectional camera module comprising a dome-shaped cover unit, the omnidirectional camera module comprising:
a body including a barrel portion in which a plurality of lenses is disposed in series and through which light introduced from one side travels and an extended portion formed to have a relatively large area on one side of the barrel portion and to communicate with the barrel portion at a central portion;
a cover unit having a shape convex to the front, having at least a portion made of a light transmitting material, surrounding the extended portion at the front, and forming a reflection space therein; and
a reflection unit including a first reflective portion formed on a front surface of the extended portion inside the reflection space to reflect light transmitted through the cover unit to the front, and a second reflective portion disposed to face the first reflective portion inside the cover unit to reflect the light reflected by the first reflective portion again so as to transmit the light to the barrel portion.

2. The omnidirectional camera module according to claim 1, wherein the extended portion is formed to be curved in a shape convex at a central portion of a front surface, and is formed to communicate with an inside of the barrel portion, and
the first reflective portion is formed to be convex corresponding to a shape of the front surface of the extended portion and is disposed toward the front inside the reflection space.

3. The omnidirectional camera module according to claim 2, wherein the first reflective portion includes a first transmitting hole communicating with the barrel portion at a central portion so that light reflected by the second reflective portion is traveled to the inside of the barrel portion.

4. The omnidirectional camera module according to claim 3, wherein the second reflective portion is disposed to face the first reflective portion and is disposed at the front of the barrel portion inside the cover unit.

5. The omnidirectional camera module according to claim 2, wherein the first reflective portion is configured as a separate member and is disposed on the front surface of the extended portion in a state of being coupled to the cover unit.

6. The omnidirectional camera module according to claim 3, wherein the second reflective portion includes a second transmitting hole at the central portion facing to the barrel portion so as to transmit light introduced through the front of the cover unit and to make the light to be traveled to the barrel portion directly.

7. The omnidirectional camera module according to claim 6, wherein the cover unit further includes an auxiliary lens formed in at least a part of the front of the second reflective portion and inducing the transmitted light to be transmitted to the second transmitting hole.

8. The omnidirectional camera module according to claim 1, wherein the first reflective portion is formed as a separate coating form on the front surface of the extended portion.

9. The omnidirectional camera module according to claim 1, wherein the cover unit includes a first coupling portion formed to surround at least a part along a periphery of the extended portion, and formed on an edge along the periphery as a protrusion or a groove, and
the extended portion includes a second coupling portion that is selectively coupled corresponding to the first coupling portion formed in the cover unit so as to be selectively coupled with each other.
